(19) United States
(12) Patent Application Publication
(10) Pub. No.: US 2011/0100821 A1
(43) Pub. Date: May 5, 2011

(54) MINERAL OIL FREE ISOELECTRIC FOCUSING APPARATUS FOR IMMOBILIZED PH GRADIENT STRIPS

(76) Inventors: Brian Furmanski, Columbia, SC (US); Brian Genge, Columbia, SC (US); Roy Wuthier, Columbia, SC (US)

(21) Appl. No.: 12/596,460

(22) PCT Filed: Apr. 21, 2008
(86) PCT No.: PCT/US08/61002

§ 371 Date: Jan. 19, 2011

Related U.S. Application Data
(60) Provisional application No. 60/925,438, filed on Apr. 20, 2007.

(51) Int. Cl. G01N 27/447; B01D 57/02

(52) U.S. Cl. 204/548; 204/644

(57) ABSTRACT

A protective sheath for use with an immobilized pH gradient (IPG) strip in an isoelectric focusing (IEF) process is generally disclosed. The protective sheath can inhibit dehydration of the IPG strip during use through loss of water to the atmosphere and/or migration of water due to electroosmotic flow without the use of mineral oil or another water-immiscible liquid. The protective sheath can generally be configured in a tube-like shape having an inner cavity. The protective sheath can define a top surface, a bottom surface, two side surfaces, a sealed end, and an open end. The top surface can have at least 2 openings, which can be covered by pull-tabs.

### PRIORITY INFORMATION

The present application claims priority to U.S. Provisional Application Ser. No. 60/925,438 filed on Apr. 20, 2007, which names Brian Furmanski, Brian Genge, and Roy Wuthier as inventors and is entitled “Mineral Oil Free Isoelectric Focusing Apparatus for Immobilized pH Gradient Strips”, the disclosure of which is incorporated by reference herein.

### BACKGROUND

Electrophoretic separations as a means of purifying proteins and separating complex protein mixtures have assumed many different forms. The separations vary in the composition of separation medium, the geometrical configuration of the medium, the manner in which mobility through the medium is achieved, and the parameter on which separation is based. One type of electrophoretic separation which is particularly useful for protein separations is a separation performed in a linear separation medium whose pH varies with the distance along the medium. A prominent example of a separation process that utilizes this type of medium is isoelectric focusing (IEF), a process by which proteins or other amphoteric substances migrate under the influence of an electric field along the pH gradient, each species continuing its migration until it reaches a location at which the pH in the medium and the isoelectric point (pl) of the species are equal. When this condition is achieved, the net charge on the species and hence the driving force for migration are zero, and migration ceases. By the completion of the procedure, the various species in a sample occupy positions in discrete, non-moving (“isoelectrically focused”) zones along the pH gradient that correspond to their isoelectric points.

Isoelectric focusing (IEF) may constitute the entire separation process, in which case the components of the sample mixture are identified by the location of the zones (in comparison to a standard) and the amount of each component is determined by the relative intensity of its zone as detected by standard detection methods. Isoelectric focusing can also serve as the first dimension of a two-dimensional separation, the second dimension being performed by placing the linear medium with its isoelectrically focused zones along one edge of a two-dimensional (slab-shaped) separation medium, preferably one that does not contain a pH gradient or one in which separation is performed by way of a separation parameter other than the isoelectric point of the species. An electric field is then imposed in a direction transverse to the linear medium, causing migration of the contents of each focused zone out of that medium and into the slab-shaped medium along parallel paths, the contents of each zone thereby undergoing further separation.

The most convenient means of achieving and maintaining the pH gradient needed for isoelectric focusing is the use of a dimensionally stable medium composed of a molecular matrix to which functional groups have been attached that are either charged or chargeable by the placement of the medium in an electric field. Strips of solid material that contain such groups are commonly referred to as “immobilized pH gradient” (IPG) strips. Examples of such strips and their composition and structure are described by Rosengren et al. in U.S. Pat. No. 4,130,470, issued Dec. 19, 1978. The solid material that forms the matrix of the strip is either a granular, fibrous, or membrane material, or a gel. Examples of suitable materials are polyacrylamide, cellulose, agarose, dextran, polyvinylalcohol, starch, silica gel, and polymers of styrene divinyl benzene, as well as combinations of these materials. Examples of positively charged or chargeable groups are amino groups and other nitrogen-containing groups. Examples of negatively charged or chargeable groups are carboxylic acid groups, sulfonic acid groups, boronic acid groups, phosphonic or phosphoric acid groups, and esters of these acids. The groups are immobilized on the matrix by covalent bonding or by any other means that will secure the positions of the groups and prevent their migration when exposed to an electric field or to the movement of fluids or solutes through the strip. When the matrix is a polymer, for example, a typical means of immobilization, is the inclusion of charged monomers to copolymerize with the uncharged monomers that form the bulk of the polymer or the inclusion of charged crosslinking agents. Copolymerization or crosslinking can be performed in a manner that will result in a monotonic increase or decrease in the concentration of the charged or chargeable groups, thereby producing the gradient.

Although IPG strips are formed in a hydrated condition, they are typically dehydrated once formed and are supplied to users in this dehydrated condition. Rehydration for use is conveniently achieved by the sample itself, which is applied to the strip and then the strip permitted to stand for a sufficient period of time to achieve full rehydration.

While IPG strips offer the advantage of a stable and well-controlled pH gradient and require only rehydration to be ready for use, their use poses certain difficulties. Once a strip is rehydrated, for example, care must be taken to assure that the strip does not suffer dehydration during use by losing water to the atmosphere. Since the strip is generally not contained in a capillary or other enclosure that would shield it from atmospheric exposure, dehydration is typically prevented by covering the strip with an electrically insulating, water-immiscible liquid such as mineral oil, and keeping the strip covered during isoelectric focusing. Furthermore, contact of the two ends of the strip with electrodes must be made and maintained through the mineral oil. In addition, once isoelectric focusing has been performed, the mineral oil must be completely removed from the strip before the strip can be used in a second dimension separation, since residual mineral oil will interfere with the electrical continuity between the strip and the slab gel.

The use of mineral oil presents several disadvantages. It requires multiple steps and the mineral oil is difficult to remove. In addition, the mineral oil may impede the transfer of protein to the second dimension slab gel.

As such, a need exists for a method of using IEF without using mineral oil to improve the appeal of using IEF to separate proteins.

### SUMMARY

Objects and advantages of the invention will be set forth in part in the following description, or may be obvious from the description, or may be learned through practice of the invention.

In general, the present disclosure is directed toward a method and apparatus for protecting an IPG strip and allowing a user to rehydrate and run the IPG strip in one device. In one embodiment, a protective sheath configured for use with an immobilized pH gradient strip is generally provided. The protective sheath is made of a plastic material shaped to form a substantially rectangular tube. The tube comprises a top surface, a bottom surface, two side surfaces, an open end, and a closed end. The top surface has two openings. One opening is located in the outer 25% of the length of the top surface adjacent the closed end, and the opposite opening is located in the outer 25% of the length of the top surface adjacent the open end. The plastic material is substantially liquid impermeable and can be substantially fluid impermeable. A pair of pull tabs covers each opening defined by the top surface and is configured to inhibit the passage of moisture through the openings. The closed end can define a bubble tab.

The protective sheath can be included in a kit along with an immobilized pH gradient strip. The protective sheath is configured for receiving the immobilized pH gradient strip through the open end.

In another embodiment, a method of using an immobilized pH gradient strip in isoelectric focusing is generally disclosed. An immobilized pH gradient strip is inserted into the protective sheath through the open end. An aqueous sample is loaded onto the immobilized pH gradient strip, and the open end can be closed to allow the immobilized pH gradient strip to rehydrate. After rehydration, the pull tabs can be removed from the protective sheath, and a pair of electrodes can be connected to the IPG strip. For example, one electrode can be connected to the IPG strip through each opening defined by the top surface of the protective sheath. A current can then be applied to the immobilized pH gradient strip through the pair of electrodes.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 is a perspective view of an exemplary protective sheath for receiving an IPG strip;

FIG. 2 is a perspective view of one embodiment of the closed end of the exemplary protective sheath;

FIG. 3 is a side view of the exemplary protective sheath for receiving an IPG strip of FIG. 1;

FIG. 4 is a top view of an exemplary protective sheath for use with the IPG sleeve of the present invention;

FIGS. 5A is a mineral oil control of an IPG strip run at a maximum of 10 kilovolts for 6.5 hours; and

FIG. 5B is an IPG strip run at a maximum of 10 kilovolts for 6.5 hours using the IPG sleeve shown in FIG. 1.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

Generally speaking, a protective sheath is disclosed herein to replace the use of mineral oil in the isoelectric focusing (IEF) process and to make the use of immobilized pH gradient (IPG) strips less labor intensive. The protective sheath can inhibit dehydration of the IPG strip during use through loss of water to the atmosphere and/or migration of water due to electroosmotic flow without the use of mineral oil or another water-immiscible liquid.

The protective sheath can be formed into any tube shape; however, the protective sheath will desirably have a shape that closely resembles the IPG strip that will be used with the protective sheath. The tube shape can essentially encompass the IPG strip protecting it from the outside environment and trapping the moisture in the IPG strip during rehydration. This sheath also allows a user to rehydrate and run the IPG strip in one device. For example, the protective sheath can be formed to have dimensions such that the IPG strip can fit within the protective sheath. Preferably, the IPG strip fits snugly within the protective sheath to inhibit the loss of water from the IPG strip. The IPG strip can fit within the protective sheath tightly such that all surfaces of the IPG strip contact the inner surfaces of the inner cavity of the protective sheath.

For example, a typical IPG strip can have a width of about 3.9 millimeters (mm), a length of about 185 mm, and a thickness from about 0.25 mm to about 0.45 mm. A protective sheath for use with this particular IPG strip can have a width W of about 4 mm, a length L of about 190 mm, and a height H of about 0.5 mm within the inner cavity of the protective sheath. However, other dimensions can be used as long as the protective sheath inhibits or substantially prevents the loss of water (i.e., evaporation) on the IPG strip during rehydration.

### I. Protective Sheath

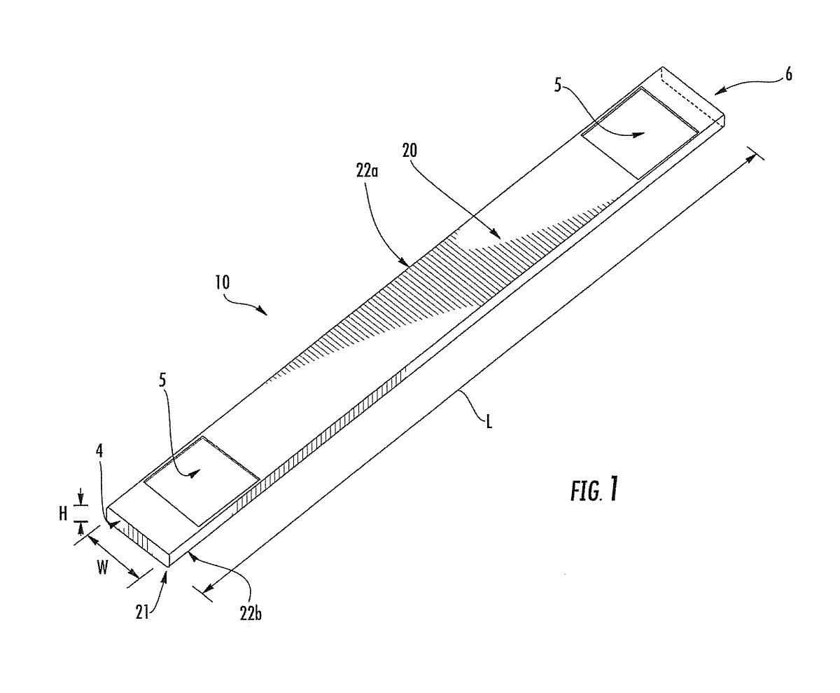

No matter the particular dimensions of the protective sheath and the IPG strip to be used with which it is to be used, the protective sheath is generally configured in a tube-like shape. For example, FIG. 1 shows an exemplary protective sheath shaped in a lay-flat tube having an inner cavity. In the shown embodiment, the protective sheath defines a top surface 20, a bottom surface 21, two side surfaces 22a, 22b, a sealed end 4, and an open end 6. The sealed end 4 shuts one end of the tube. The open end 6 is opposite the sealed end 4 and remains open to allow access to the interior of the protective sheath. Specifically, the open end 6 is configured to allow a user to insert an IPG strip into the protective sheath. The open end 6 also allows the user to load the sample onto the IPG strip, which starts the rehydration process of the IPG strip.

The closed end 4 is located opposite the open end 6. The closed end 4 can be simply shaped in a rectangular form, as shown in FIGS. 1 and 3. Alternatively, the closed end 4 can be shaped to form an extra amount of space. For example, FIG. 3 shows the closed end 4 shaped to define a bubble tab that can be utilized to create a vacuum force on the open end 6 as explained in greater detail below.

The top surface 20 the protective sheath 10 has two openings 5 near the ends 4, 6 to allow electrical contact between the gel surface of the underlying IPG strip and an electrode. However, during the rehydration process, two pull tabs 12, such as shown in FIG. 3, cover the openings 5 in the top surface 20 of the protective sheath 10. The pull tabs 12 cover the openings 5 during the rehydration process, but can be pulled off to connect the IPG strip to the electrode and begin the IEF run. The removal of the pull tabs 12 allows direct access to the gel surface of the underlying IPG strip insuring good electrical contact. As shown in FIG. 3, the pull tab 5 can extend beyond the openings 5 to create an unconnected portion of the pull tab 5, enabling the user to remove the pull tab 12 by simply pulling on the unconnected portion. In one embodiment, the unconnected portion can be creased up to help the user locate and remove the pull tab 12 from the openings 12.

The openings 5 are generally spaced close to the ends 4, 6 of the top surface 20, as stated. For example, each opening 5 can be positioned in the outer 25% of the overall length L of the top surface of the protective sheath 10.

The size of the openings 5 is configured to allow an electrode to penetrate the top surface 20 of the protective sheath such that the electrode can contact the underlying IPG strip. In one embodiment, the openings 5 can be the just larger than the size of the electrodes to be attached to the IPG strip. For example, when the electrode is simply a wire (e.g., a platinum wire) to be attached to the IPG strip, the openings 5 do not have to be very large (e.g., less than 1 mm², as measured in the surface area of the top surface 20). However, for convenience of use, the openings 5 can be larger than necessary to facilitate connection of the electrodes to the IPG strip. For example, each opening 5 can define an open area in the top surface that is at least about 1 mm², such as from about 6 mm² to about 100 mm². In one embodiment, each opening 5 can span the entire width W of the top surface 20 of the protective sheath 10 and can be from about 10 mm to about 15 mm in length (e.g., in the exemplary protective sheath described above having a width of about 4 mm, the openings 5 would each define an area from about 40 mm² to about 60 mm²).

Although the openings 5 are shown to be rectangular in shape, the openings 5 can define any shape sufficient to allow the user to insert an electrode through the top surface 20 and connect to the underlying IPG strip. Other suitable shapes include, but are not limited to, circles, diamonds, squares, triangles, and the like.

The protective sheath is configured to contain an IPG strip and to inhibit dehydration of the IPG strip during use. Thus, the protective sheath substantially inhibits or completely prevents the passage of water through it. In one particular embodiment, the protective sheath can be constructed from a plastic material (i.e., a synthetic polymeric material) that is substantially liquid impermeable. The plastic material can also be substantially gas impermeable (i.e., not breathable). When the plastic material is substantially liquid impermeable and substantially gas impermeable, it can be described as “fluid impermeable.” Thus, the fluid impermeable plastic material provides similar protective properties like those of mineral oils, but without the many disadvantages. Desirably, the plastic material used is non-conductive, gas impermeable, liquid impermeable, heat transmissive, malleable/conformable, non-adhesive, chemically resistant and/or combinations thereof. Also, the protective sheath can be configured to withstand exposure to the electrical charges experienced during the IEF run. Voltages up to 10,000 volts can be applied to the IPG strip, so the protective sheath is configured to withstand these relatively high voltages.

In one particular embodiment, the protective sheath is constructed from a soft, malleable plastic material. Suitable plastic materials include, but are not limited to, polyesters (e.g., polyethylene terephthalate), polyethylenes (e.g., polytetrafluoroethylene), polypropylenes, perfluoroalkoxy (e.g., Teflon-PFA® sold by DuPont), and copolymers, derivatives thereof. Also, a combination of these or other polymers can be utilized to form the plastic material of the protective sheath. Other materials can also be present to add desired properties to the protective sheath. For example, other processing aides can be present to facilitate formation of the protective sheath, including but not limited to surfactants, plasticizers, and the like.

Antistatic agents, particularly polymeric antistatic agents, can also be combined with the plastic material to reduce the build-up of electrical or static charge in the protective sheath before or during the IEF run. Examples of suitable polymeric antistatic materials can include, but are not limited to, polyvinyl alcohols, polyvinyl acetates, polyethylene glycol, polypropylene glycol, and the like. The antistatic agent can be present in the polymeric material in an amount sufficient to inhibit the build-up of a static charge on the protective sheath during the IEF run. In one embodiment, the antistatic agent can be present in an amount of about 1% by weight to about 25% by weight, such as from about 5% by weight to about 10% by weight, based on the dry weight of the protective sheath. In one particular embodiment, the protective sheath is constructed from polyethylene terephthalate (PET) combined with polyvinyl alcohol (such as the EVOH material available under the trade name EVAL® from EVAL Company of America, Houston).

The use of soft malleable plastic in the present apparatus allows for a tighter fit of the IPG strip when compared with rigid plastic designs. For example, the protective sheath can be just small enough to allow the rehydrated IPG strip to push and slightly stretch the plastic tube, thus insuring a proper fit.

No matter its composition, the plastic material can be extruded, molded, or otherwise shaped into a tube as described above.

### II. Method of Using Protective Sheath

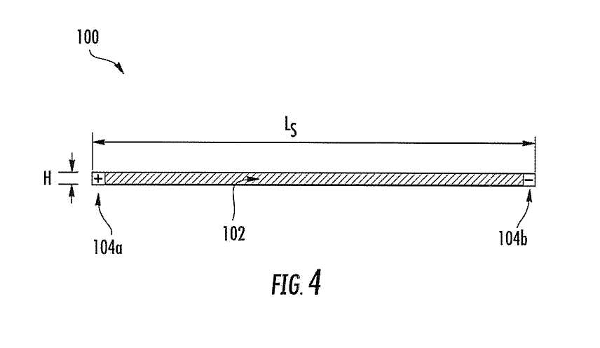

In order to use the protective sheath 10, the IPG strip is first inserted into the protective sheath though the open end 6. The IPG strip is inserted gel side up in a protective sheath of matching length (such as 70 mm IPG strip in a 90 mm protective sheath). The gel side of the IPG strip is oriented such that the openings 5, which are covered by the pull tabs 12 during insertion of the IPG strip, can expose the gel side. FIG. 4 shows an exemplary IPG strip 100 having a gel side 102 and two opposite electrode connectors 104a, 104b. The IPG strip 100 has a length Lₛ that is shorter than the length L of the protective sheath 10 to which it is to be inserted.

The insertion of the IPG strip into the protective sheath 10 through the open end 6 can be performed by the user of the IPG strip, or can be performed at a prior time. For example, the protective sheath can be manufactured with the IPG strip already inserted by the manufacturer, or another party, prior to reaching the user who will ultimately run the IEF.

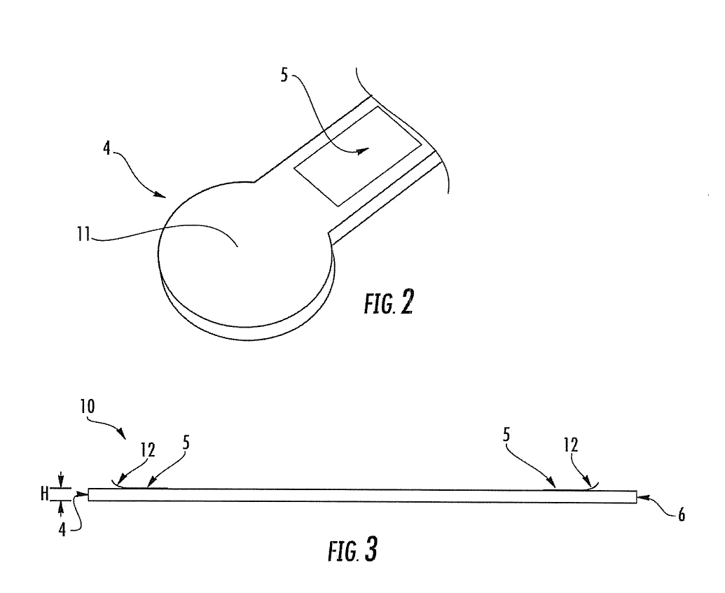

The sample (typically in an aqueous solution including a rehydration buffer as stated by the IPG strip manufacturer) is loaded into the protective sheath and onto the IPG strip through the open end 6. For example, the open end 6 can be contacted with the sample. In one particular embodiment, the sample can be drawn into the protective sheath and onto the IPG strip through the use of a vacuum force. A vacuum force can be created in the protective sheath by squeezing the closed end 4, especially when formed with a bubble as shown in FIG. 2, then submersing the open end 6 into the sample. Upon releasing the squeezing force on the closed end 4, the protective sheath tends to expand back to its original shape. This expansion creates a low pressure area, resulting in a vacuum force being applied to the open end 6 sufficient to draw the sample into the protective sheath and onto the IPG strip. In one embodiment, the protective sheath has a vertical top loading position which reduces the risk of air bubble formation in the tube.

After loading the sample into the protective sheath and onto the IPG strip, the open end 6 is closed to inhibit loss of the sample or moisture during rehydration of the IPG strip. Closing the open end 6 can be performed by capping it with a cap manufactured to fit within the open end 6. Alternatively, the open end 6 can be taped shut with a suitable material (e.g., Scotch® tape, 3M Corp.). Any method can be used to seal shut the open end 6 to inhibit evaporation during the rehydration process.

The IPG strip is allowed to sit for a period sufficient to rehydrate the IPG strip. For example, the IPG strip can be allowed to rehydrate for an appropriate period of time, typically from about 10 hours to about 16 hours.

After the rehydration procedure is complete, the user can then remove the pull tabs 12 to expose the gel surface through the openings 5 of the top surface 20. Electrodes can then be positioned on the exposed gel surface of the IPG strip. The focusing procedure is then carried out per instructions of the IPG strip manufacturer.

In one embodiment, the focusing procedure can be performed using an isoelectric focusing apparatus, such as the isoelectric focusing apparatus Protean IEF cell sold by Bio-Rad Laboratories, Inc. (Hercules, Calif.), having electrodes ready for an IPG strip to be placed on it. This type of apparatus has a surface where two electrodes are positioned at an appropriate distance from each other to accommodate the particular IPG strip. To use this apparatus, the IPG strip is placed on the apparatus gel side down so that the gel side of the IPG strip contacts the electrodes.

During the IEF run, a current is applied to the IPG strip as is known in the art. The duration of the IEF run can vary depending on the length of the IPG strip, but is typically from about 2 to about 7 hours. The current applied can be in voltages up to about 10,000 volts.

After the focusing run, the gel can be removed from the protective sheath. In one embodiment, a built in preset or score line (not shown) running along the length of the protective sheath allows the user to remove the IPG strip without disturbing the gel. In alternative embodiments, the user can simply cut and/or tear the protective sheath off of the IPG strip. The user can then stain or use the IPG strips for the second dimension electrophoresis.

### EXAMPLES

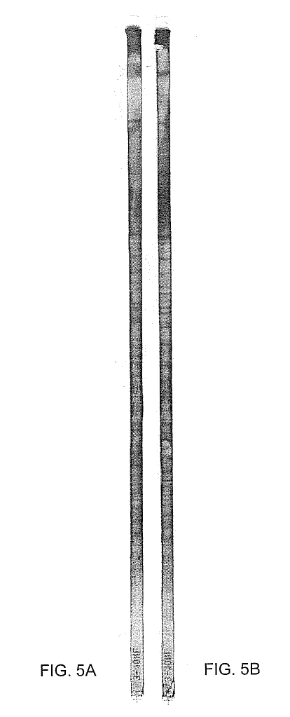

Two identical samples were run on (1) a control IPG strip shown in FIG. 5A was performed conventionally using mineral oil and (2) an IPG strip shown in FIG. 5B was performed while the IPG strip encompassed by a protective sheath. Both samples were run at a maximum of 10 kilovolts for 6.5 hours. Each strip was stained with Coomassie blue to show protein banding patterns. This protein banding patterns on the strips were nearly identical, showing that the protective sheath did not substantially alter the results of the IEF run.

The foregoing description along with other modifications and variations to the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention.

What is claimed:

1. A protective sheath configured for use with an immobilized pH gradient strip, the protective sheath comprising:
a plastic material shaped to form a substantially rectangular tube, wherein the tube defines a length and comprises a top surface, a bottom surface, two side surfaces, an open end, and a closed end, wherein the top surface comprises two openings, one opening being located in the outer 25% of the length of the top surface adjacent the closed end and the opposite opening being located in the outer 25% of the length of the top surface adjacent the open end, wherein the plastic material is substantially liquid impermeable; and
a pair of pull tabs, one pull tab covering each opening defined by the top surface, the pair of pull tabs configured to inhibit the passage of moisture through the openings.

2. A protective sheath as in claim 1, wherein the closed end defines a bubble tab.

3. A protective sheath as in claim 1, wherein the plastic material is substantially fluid impermeable.

4. A protective sheath as in claim 1, wherein the plastic material comprises a polyester.

5. A protective sheath as in claim 4, wherein the plastic material comprises polyethylene terephthalate.

6. A protective sheath as in claim 1, wherein the plastic material comprises a polyethylene.

7. A protective sheath as in claim 6, wherein the plastic material comprises polytetrafluoroethylene.

8. A protective sheath as in claim 1, wherein the plastic material comprises a perfluoroalkoxy.

9. A protective sheath as in claim 1, wherein the plastic material comprises an antistatic agent.

10. A protective sheath as in claim 1, wherein the plastic material comprises polyvinyl alcohol.

11. A kit comprising the protective sheath of any of the preceding claims and an immobilized pH gradient strip, wherein the protective sheath is configured for receiving the immobilized pH gradient strip through the open end.

12. A method of using an immobilized pH gradient strip in isoelectric focusing, the method comprising:
providing a protective sheath comprising a plastic material shaped to form a substantially rectangular tube and a pair of pull tabs, wherein the tube defines a length and comprises a top surface, a bottom surface, two side surfaces, an open end, and a closed end, wherein the top surface comprises two openings, wherein the plastic material is substantially liquid impermeable, wherein one pull tab covers each opening defined by the top surface, the pair of pull tabs configured to inhibit the passage of moisture through the openings;
inserting an immobilized pH gradient strip into the protective sheath through the open end;
loading an aqueous sample onto the immobilized pH gradient strip;
closing the open end of the protective sheath to allow the immobilized pH gradient strip to rehydrate;
removing the pull tabs from the protective sheath;
connecting a pair of electrodes to the IPG strip, wherein one electrode is connected to the IPG strip through each opening defined by the top surface of the protective sheath; and
applying a current to the immobilized pH gradient strip through the pair of electrodes.

13. A method as in claim 12, wherein one opening is located in the outer 25% of the length of the top surface adjacent the closed end and the opposite opening is located in the outer 25% of the length of the top surface adjacent the open end.

14. A method as in claim 12, wherein the closed end defines a bubble tab, and wherein the step of loading the aqueous sample onto the immobilized pH gradient strip comprises:
squeezing the bubble tab together, and
releasing the bubble tab to create a vacuum force in the protective sheath such that the aqueous sample is sucked into the open end of the protective sheath.

15. A method as in claim 12, wherein the plastic material is substantially fluid impermeable.

16. A method as in claim 12, wherein the plastic material comprises polyethylene terephthalate.

17. A method as in claim 12, wherein the plastic material comprises an antistatic agent.

18. A method as in claim 12, wherein the plastic material comprises polyvinyl alcohol.

19. A method as in claim 12, further comprising
removing the protective sheath from the immobilized pH gradient strip after applying the current to the immobilized pH gradient strip.

20. A method as in claim 12, wherein mineral oil is not used in the method.
